(19) United States
(12) Patent Application Publication
(10) Pub. No.: US 2023/0324186 A1
(43) Pub. Date: Oct. 12, 2023

(54) ROUTE INFORMATION PROVIDING DEVICE AND ROUTE INFORMATION PROVIDING METHOD

(71) Applicant: TOYOTA JIDOSHA KABUSHIKI KAISHA, Toyota-shi Aichi-ken (JP)

(72) Inventors: Miki NOMOTO, Nagoya-shi Aichi-ken (JP); Yuka Nishiyama, Toyota-shi Aichi-ken (JP); Kenichi Okumura, Gotemba-shi Shizuoka-ken (JP); Ryota Tomizawa, Mishima-shi Shizuoka-ken (JP); Tatsuya Sugano, Sunto-gun Shizuoka-ken (JP); Yushi Seki, Ashigarakami-gun Kanagawa-ken (JP); Tokuhiro Masui, Nagoya-shi Aichi-ken (JP)

(73) Assignee: TOYOTA JIDOSHA KABUSHIKI KAISHA, Toyota-shi Aichi-ken (JP)

(21) Appl. No.: 18/105,053

(22) Filed: Feb. 2, 2023

(30) Foreign Application Priority Data
Apr. 8, 2022 (JP) 2022-064548

(51) Int. Cl. G01C 21/34

(52) U.S. Cl. CPC G01C 21/3438; G01C 21/343

(57) ABSTRACT

A route information providing device assists movement of a group with a plurality of members, and includes a communication device and a processor. The communication device is configured to communicate with a communication terminal of each member. The processor is configured to execute: a route generation process to generate a movement route of each member including one or more meeting places where some or all members of the group meet, based on member information including a departure place, a departure time, one or more stop-off places, one or more desired meeting places, an arrival time at each of the one or more desired meeting places, and individual characteristics; a time calculation process to calculate a meeting time of each of the one or more meeting places; and a sharing process to share, in the group, a generated movement route of each member and a calculated meeting time.

### CROSS-REFERENCE TO RELATED APPLICATION

The present disclosure claims priority under 35 U.S.C. § 119 to Japanese Patent Application No. 2022-064548, filed on Apr. 8, 2022, which is incorporated herein by reference in its entirety.

### BACKGROUND

### Technical Field

The present disclosure relates to a route information providing device and route information providing method for assisting the movement of a group with a plurality of members.

### Background Art

JP 2003-114135 A discloses a geographic information providing device. This geographic information providing device is configured to present a route suitable for each user's request on the basis of the user's desired area, time zone, self attributes, and preference.

### SUMMARY

There are the following problems regarding the movement of a plurality of persons (more specifically, the movement of a group with a plurality of members) for the purpose of, for example, travel. For example, in a trip of a family with a difference in physical strength, it may be necessary to determine items such as a stop-off place and a time schedule in consideration of “individual characteristics” such as preference, interest, or physical strength of a specific person. Further, in an example in which each of the members in the group desires a different movement route (i.e., individual behavior), it may be troublesome to adjust and determine, among the members, a place (meeting place) and a time (meeting time) at which a plurality of members meet.

The present disclosure has been made in view of the problem described above, and an object thereof is to provide a route information providing device and route information providing method that can generate a movement route in consideration of individual characteristics of each member while reducing troublesomeness of adjustment related to the meeting of a plurality of members of a group.

A route information providing device according to the present disclosure assists movement of a group with a plurality of members. The route information providing device includes a communication device and a processor. The communication device is configured to communicate with a communication terminal of each member of the group. The processor is configured to execute: a route generation process to generate a movement route of each member including one or more meeting places where some or all members of the group meet, based on member information including a departure place, a departure time, one or more stop-off places, one or more desired meeting places, an arrival time at each of the one or more desired meeting places, and individual characteristics; a time calculation process to calculate a meeting time of each of the one or more meeting places; and a sharing process to share, in the group, a generated movement route of each member and a calculated meeting time.

In the sharing process, when an additional request from a member of the group to add a meeting place where some or all of the members of the group meet is received, the processor may share, in the group, the meeting place and a meeting time according to the additional request.

The route generation process may include an alternative route generation process that, when a notification from a specific member of the group to indicate that the specific member cannot meet at a specific meeting place included in the one or more meeting places is received, generates an alternative movement route including a meeting place closer to the specific member than the specific meeting place.

The route generation process may include an alternative route generation process that, when a notification from a specific member of the group to indicate that the specific member cannot meet at the meeting place according to the additional request is received, generates an alternative movement route including a meeting place closer to the specific member than the meeting place according to the additional request.

When receiving a notification from a specific member of the group to indicate that the specific member cannot meet at a specific meeting place included in the one or more meeting places, the processor may execute a notification process to send a notification for calling attention to an exchange of information between the specific member and one or more members meeting at the specific meeting place after the meeting time at the specific meeting place arrives.

When receiving a notification from a specific member of the group to indicate that the specific member cannot meet at the meeting place according to the additional request, the processor may execute a notification process to send a notification for calling attention to an exchange of information between the specific member and one or more members meeting at the meeting place according to the additional request after the meeting time at the meeting place according to the additional request arrives.

A route information providing method according to the present disclosure assists movement of a group with a plurality of members. The route information providing method includes: generating a movement route of each member including one or more meeting places where some or all members of the group meet, based on member information including a departure place, a departure time, one or more stop-off places, one or more desired meeting places, an arrival time at each of the one or more desired meeting places, and individual characteristics; calculating a meeting time of each of the one or more meeting places; and sharing, in the group, a generated movement route of each member and a calculated meeting time.

Each of the route information providing device and the route information providing method according to the present disclosure makes it possible to generate a movement route in consideration of individual characteristics of each member while reducing troublesomeness of adjustment related to the meeting of a plurality of members of a group.

### BRIEF DESCRIPTION OF THE DRAWINGS

FIG. 1 is a diagram illustrating an example of a configuration of a route information providing device according to an embodiment;

FIG. 2 is a flowchart showing a flow of processing related to movement assistance for a group G according to the embodiment;

FIG. 3 is a flowchart showing an example of a specific flow of processing for each member M in step S104;

FIG. 4 is a diagram illustrating an example of movement route of each member M generated by a route generation process according to the embodiment;

FIG. 5 is a diagram illustrating another example of the movement route of each member M generated by the route generation process according to the embodiment;

FIG. 6 is a flowchart showing a flow of an alternative route generation process according to the embodiment; and

FIG. 7 is a flowchart showing a flow of a notification process according to the embodiment.

### DETAILED DESCRIPTION

In the following, embodiments of the present disclosure will be described with reference to the accompanying drawings. However, it is to be understood that even when the number, quantity, amount, range, or other numerical attribute of an element is mentioned in the following description of the embodiments, the present disclosure is not limited to the mentioned numerical attribute unless explicitly described otherwise, or unless the present disclosure is explicitly specified by the numerical attribute theoretically.

### 1. Configuration of Route Information Providing Device

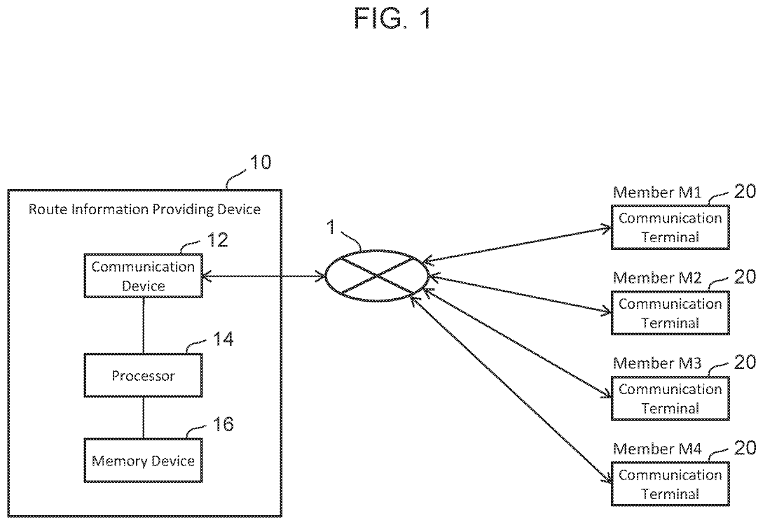

FIG. 1 is a diagram illustrating an example of a configuration of a route information providing device 10 according to an embodiment. The route information providing device (hereinafter, may be simply abbreviated as “providing device”) 10 assists the movement of a group G with a plurality of members M. More specifically, the providing device 10 assists both the movement of each member M in the group G as an individual and the movement as the group G. An example of the “movement” referred to here is a travel for the purpose of, for example, sightseeing.

The “group G” is composed of a plurality of members M (i.e., n members M1 to Mn) each carrying a communication terminal 20. For example, the group G is a single family constituted by a plurality of members. In this example, each of the plurality of members constituting the single family, for example, corresponds to the member M. Moreover, in an example in which the “movement” is a school trip, each of the individual students and a teacher who draws the students corresponds to the member M. It should be noted that the number of members M carrying the communication terminals 20 and the number of persons participating in the “movement” such as a travel may not necessarily be the same. Each member M may be accompanied by an accompanying person who performs the same behavior. That is, for example, a member M may be Mr. A who is a representative of a meeting of the member M himself (i.e., Mr. A) and one or more accompanying persons (for example, the wife and the child of Mr. A).

The providing device 10 is a server and is a computer configured to execute various processes related to the movement assistance for the group G. The various processes referred to here include a “route generation process”, a “time calculation process”, and a “sharing process” that are described below.

Specifically, the providing device 10 includes a communication device 12, a processor 14, and a memory device 16. The communication device 12 communicates with the communication terminals 20 via a communication network 1 such as a wireless network. In the example shown in FIG. 1, the group G is constituted by four members M (M1 to M4), and thus four communication terminals 20 are illustrated in FIG. 1.

The processor 14 executes the various processes described above. The memory device 16 stores various kinds of information. The memory device 16 includes, for example, a volatile memory, a nonvolatile memory, a hard disk drive (HDD), and a solid state drive (SSD). When the processor 14 executes various computer programs, various processes by the processor 14 are realized. The various programs are stored in the memory device 16 or recorded in a computer-readable recording medium. It should be noted that the providing device 10 may include a plurality of processors 14 and a plurality of memory devices 16.

Each communication terminal 20 is, for example, a smartphone or a tablet personal computer. The communication terminal 20 includes a processor, a memory device, and a communication device. In addition, the communication terminal 20 can acquire position information of the member M carrying the communication terminal 20, based on a signal from a global navigation satellite system (GNSS) satellite.

### 2. Movement Assistance for Group G

In order to realize the movement assistance that can generate a movement route in consideration of the individual characteristics of each member M while reducing troublesomeness of adjustment related to the meeting of the plurality of members M of the group G, the processor 14 of the route information providing device 10 executes the “route generation process”, the “time calculation process”, and the “sharing process”.

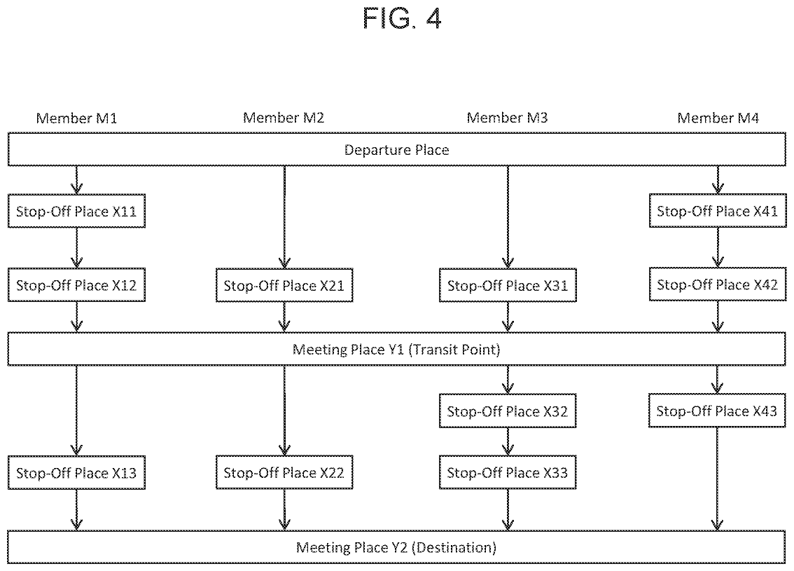

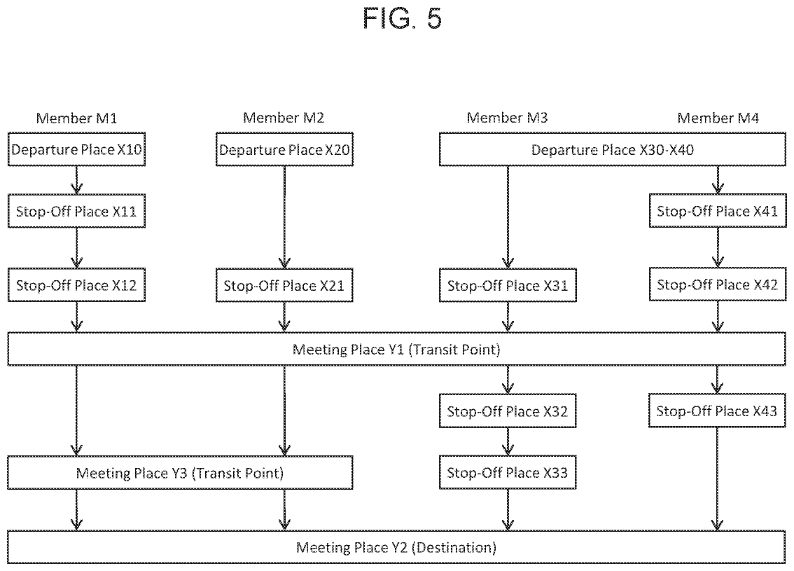

Specifically, in the route generation process, the processor 14 generates a movement route (for example, see FIG. 4 or 5 described below) of each of the members M including one or more meeting places Y where some or all of the members M of the group G meet, based on member information MI. The member information MI of each member M includes a departure place, a departure time (or departure time point), one or more stop-off places X, one or more desired meeting places Yr, an arrival time (or arrival time point) at each of the one or more desired meeting places Yr, and individual characteristics C.

In the time calculation process, the processor 14 calculates a meeting time (or meeting time point) of each of the one or more meeting places Y. Then, in the sharing process, the processor 14 shares the generated movement route of each of the members M and the calculated meeting time in the group G.

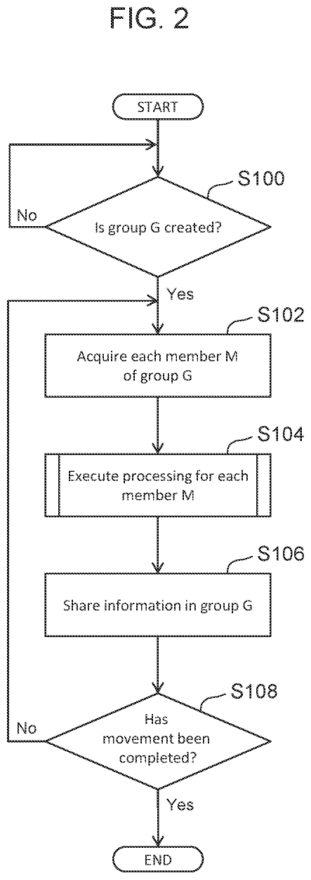

FIG. 2 is a flowchart showing a flow of processing related to the movement assistance for the group G according to the embodiment. A user of the providing device 10 uses the communication terminal 20 to activate a dedicated application for the movement assistance, input personal information for specifying the user such as a name and a mail address, and perform member registration of the application. The user who has completed the member registration can input (register) information of the group G and the member information MI by using the communication terminal 20. The input information of the group G and member information MI are stored in a user information database of the memory device 16.

In FIG. 2, in step S100, the processor 14 determines, based on the information of the user information database, whether or not a new group G has been registered by a user. As a result, when a new group G is created (registered), the processing proceeds to step S102.

In step S102, the processor 14 acquires (specifies) each member M of the group G based on the information of the user information database. The information of the group G in the user information database includes, for example, personal information (for example, name) for specifying each member M constituting the group G.

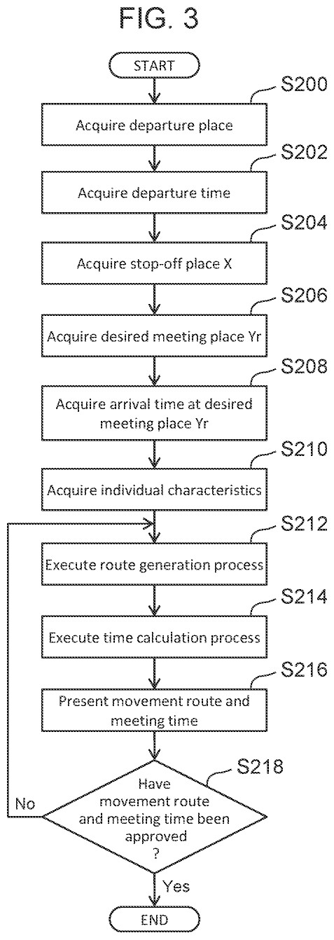

In step S104, the processor 14 executes a process for each member M belonging to the group G. FIG. 3 is a flowchart showing an example of a specific flow of processing for each member M in step S104. The processing of this flowchart is executed for each member M, for example, after the input of the member information MI of all the members M is completed.

In FIG. 3, in steps S200 to S210, the processor 14 sequentially acquires a departure place, a departure time, one or more stop-off places X, one or more desired meeting places Yr, an arrival time at each of the one or more desired meeting places Yr, and individual characteristics C of the member M, based on information of the user information database.

The one or more stop-off places X include, for example, various sightseeing spots and various stores (for example, restaurants). The one or more desired meeting places Yr includes, for example, accommodation facilities, and the house of the member M as well as various sightseeing spots and various stores.

The individual characteristics C include information about individual preferences and interests. The individual characteristics C may also include, for example, information indicating physical characteristics such as age. Further, the individual characteristics C may include information indicating whether or not the member M has a driving license for a vehicle such as an automobile.

In addition, the member information MI may include information on a desired stay time at each of one or more stop-off places X. Similarly, the member information MI may include information on a desired stay time at each of one or more desired meeting places Yr.

Next, in step S212, the processor 14 executes the “route generation process” described above. Specifically, the memory device 16 also stores a route information database that stores various kinds of information (for example, various kinds of traffic information such as road traffic information and train route information, various kinds of map information such as a road map and a train route map, information on various sightseeing spots, and information on various shops) that is a basis for the route generation. The processor 14 generates a movement route of the member M based on the member information MI and information of the route information database by executing a predetermined route search algorithm.

FIG. 4 is a diagram illustrating an example of the movement route of each member M generated by the route generation process according to the embodiment. FIG. 4 corresponds to an example in which the members M constituting the group G are four members M1 to M4.

The departure place is, for example, a train station or the house of each member M. In the example shown in FIG. 4, the departure places of the members M1 to M4 are the same. In addition, as shown in FIG. 4, the movement route of each of the members M1 to M4 includes stop-off places X (for example, X11 to X13, X21, X22, X31 to X33, and X41 to X43) that are different in number and place depending on the member M. These stop-off places X are included along with the wishes (i.e., member information MI) of each member M.

Furthermore, the movement route of each of the members M1 to M4 includes meeting places Y1 and Y2 which are examples of the meeting place Y described above. In the route generation process, the processor 14 determines the meeting places Y1 and Y2 on the basis of a desired meeting place Yr and the arrival time at the desired meeting place Yr included in the member information MI of each of the members M1 to M4 in consideration of the relation between the desired meeting places Yr and the stop-off places X of the members M. In addition, the member information MI may include information indicating which of the stop-off place X and the desired meeting place Yr is prioritized in the determination of the meeting place Y by the processor 14. Then, the processor 14 may determine the meeting place Y also in consideration of the information on the priority.

The example of the movement route illustrated in FIG. 4 includes the meeting place Y1 which is a transit point and the meeting place Y2 which is a final destination (final arrival point) such as an accommodation facility or a house. Instead of this example, one meeting place Y or three or more meeting places Y may be provided. Also, the meeting place Y may be only one or more transit points. That is, the final destination may be different for each member M. Further, the meeting place Y may be only the final destination.

Moreover, the route generation process includes a process of determining the transportation method used by the member M in each section on the movement route of each member M (for example, between the departure place and the stop-off place X, between two stop-off places X, and between the stop-off place X and the meeting place Y). The transportation method includes, for example, a mobile body such as an automated driving vehicle, a train, a bullet train, a bus, a taxi, a ship, and an airplane, and walking. In the example of travel at a sightseeing spot, the transportation method also includes, for example, a rikshaws and a vehicle provided by a transportation service in a hotel.

The processor 14 determines the transportation method of each section on the movement route of each member M in consideration of the member information MI described above. At this time, the processor 14 may determine the transportation method such that a plurality of members M move in a section by the same transportation method. More specifically, the processor 14 may determine the transportation method such that, for example, each member M moves from a departure place to a meeting place Y using an individual transportation method, and a plurality of members M joining at the meeting place Y thereafter move using the same transportation method. Conversely, the processor 14 may determine the transportation method such that, for example, a plurality of members M move from the departure place to the meeting place Y using the same transportation method, and each member M moves using an individual transportation method after arriving at the meeting place Y.

Furthermore, the processor 14 may determine the transportation method in consideration of the individual characteristics C as follows. That is, for example, the physical characteristics of the member M may be considered as follows. For example, in an example in which the member M is an elderly person, the processor 14 may determine the transportation method of the member M while excluding public transportation (for example, a bus) and walking or limiting walking time to a short time. Alternatively, in an example of the member M using a wheelchair, the processor 14 may add a barrier-free vehicle to the options of the transportation method. In addition, the processor 14 may present a barrier-free store to the member M as one of the stop-off places X. Further, in an example of the member M who has a driving license of a vehicle such as an automobile, a rental car, for example, may be added to the options of the transportation method.

FIG. 5 is a diagram illustrating another example of the movement route of each member M generated by the route generation process according to the embodiment. The example of the movement route shown in FIG. 5 is different from the example shown in FIG. 4 in the points described below. That is, the departure places (X10, X20, and X30 to X40) are different between the member M1, the member M2, and the members M3 and M4. In addition, this example includes a meeting place Y3 (transit point) where only some members M1 and Y2 included in the group G meet. It should be noted that, instead of or in addition to the transit point, the final destination may be a meeting place Y where only some members M constituting the group G meet. Also, the departure dates of the members M may not necessarily be the same.

In step S214 subsequent to step S212, the processor 14 executes the “time calculation process” described above. To be specific, the processor 14 calculates a meeting time at each of the one or more meeting places Y generated in step S212. The meeting time is determined, for example, based on a predicted arrival time at the meeting place Y of each member M moving along each movement route. The meeting time is calculated for each of the meeting places Y1 and Y2 in the example shown in FIG. 4, and is calculated for each of the meeting places Y1 to Y3 in the example shown in FIG. 5.

Next, in step S216, the processor 14 presents the movement route generated in step S212 and the meeting time calculated in step S214 to the member M who uses the movement route. Specifically, a notification regarding the movement route and the meeting time is transmitted to the communication terminal 20 of the member M.

Additionally, in association with the processing in steps S214 and S216, the processor 14 may automatically calculate a stay time at each of one or more meeting places Y, and may present (notify) the stay time to the member M together with the movement route and the meeting time. Similarly, the processor 14 may automatically calculate a stay time at each of one or more stop-off places X, and may present (notify) the stay time to the member M together with the movement route and the meeting time.

Next, in step S218, the processor 14 determines whether or not the member M who has received the notification regarding the movement route and the meeting time has approved the movement route and the meeting time. This determination can be performed, for example, based on which of an approval operation and a disapproval operation has been performed by the member M using the communication terminal 20.

When the determination result of step S218 is Yes (i.e., when the member M has approved the movement route and the meeting time), the processing of the flowchart shown in FIG. 3 ends. When, on the other hand, the determination result is No (i.e., when the member M has not approved the movement route and the meeting time), the processor 14 executes the processing of step S212 and the subsequent steps again to correct at least one of the movement route and the meeting time, in order to present a movement route and a meeting time which are acceptable to the member M. For this modification, the processor 14 may receive information from the member M indicating a desire for the modification.

In FIG. 2, the processing of step S106 subsequent to step S104 is executed after all the members M approve the movement route and the meeting time in the processing of the flowchart shown in FIG. 3. In step S106, the processor 14 executes the “sharing process” described above. That is, the processor 14 executes a process of sharing the generated movement route of each member M and the calculated meeting time in the group G.

Specifically, in order to share information in the sharing process, the processor 14 notifies all the members M of the information on the movement route and the meeting time of each member M by, for example, transmitting the information to the communication terminals 20 of all the members M. The notification can be performed using, for example, e-mail or chat. More specifically, the information for information sharing is transmitted, for example, as a text mail in which the movement route and the meeting time of each member M are described, or as a link of a website that displays the movement route and the meeting time of each member M.

Next, in step S108, the processor 14 determines whether or not the movement of the group G has been completed. This determination can be performed based on, for example, whether or not a predetermined operation of the communication terminal 20 for notifying the providing device 10 that the movement has been completed has been performed by all the members M.

When the determination result of step S108 is Yes (i.e., when the movement of the group G has been completed), the processing of the flowchart shown in FIG. 2 ends. That is, the movement assistance by the providing device 10 is ended.

When, on the other hand, the result of the determination in step S108 is No (i.e., when the movement of the group G is not completed), the processor 14 repeatedly executes the processing of step S102 and the subsequent steps. That is, the providing device 10 receives a change (for example, addition or deletion) of the member M and a change of the member information MI associated with steps S200 to S210 until the movement of the group G is completed. When the member M is changed or the member information MI is changed, the processor 14 updates the movement route and the meeting time of the corresponding member M according to the change.

### (Processing When Meeting is Added)

It is assumed that the member M wishes to add a meeting place Y during the execution of the movement using the assistance by the providing device 10 (for example, before the meeting time of the meeting place Y that is set in advance arrives).

In this regard, according to the processing of the flowchart shown in FIG. 2 executed as described above, when a request (additional request) to add a meeting place Y where some or all of the members M of the group G meet is received from a member M by changing the member information MI, the processor 14 updates the movement route of each of the members M related to the addition so as to include the meeting place Y based on the desired meeting place Yr according to the additional request (step S212). In addition, the processor 14 calculates a meeting time at the meeting place Y according to the additional request (step S214). Then, the processor 14 causes the group G to share the movement routes including the meeting place Y according to the additional request and the corresponding meeting time (step S106).

As described above, the “sharing process” executed when the “additional request” is received from a member M who changes the member information MI includes sharing, in the group G, the meeting place Y and the meeting time according to the additional request. In addition, the notification of the meeting place Y and the meeting time to the members M for the sharing may be performed only to the members M related to the addition request, or may be performed to all the members M.

### 3. Effect

As described above, according to the route information providing device 10 of the present embodiment, in a movement planning such as a trip in the group G, the movement route of each of the members M belonging to the group G is automatically generated in consideration of the “individual characteristics” such as individual preference. The movement route of each member M includes one or more meeting places Y where some or all of the members M of the group G meet. Also, the meeting time at each of the one or more meeting places Y is automatically calculated. Then, the sharing process is performed to share the movement route of each member M and the meeting time in the group G.

As described above, according to the route information providing device 10, it is possible to generate a movement route in consideration of the individual characteristics of each member M while reducing the troublesomeness of adjustment related to the meeting of the plurality of members M in the group G. That is, it is possible to favorably assist both the movement of each member M in the group G as an individual and the movement as a group.

Furthermore, according to the above-described processing when a meeting is added, a member M can additionally create a meeting of at least a part of the plurality of members M using the providing device 10 in accordance with a situation during movement using the assistance by the providing device 10 (for example, a situation on the day of the movement described below), and can share information on the additional meeting among the members M.

### 4. Processing When Meeting is Not Possible

It is assumed that a member M cannot meet at the meeting place Y set in advance at the meeting time due to circumstances on the day of the movement using the assistance by the providing device 10. The situation on the day of the movement referred to here is, for example, that it is difficult for a member M to walk to the meeting place Y because the member M is old, or that the stop-off place X is congested. In view of this point, the processor 14 may execute at least one of the following “alternative route generation process” and “notification process”.

### 4-1. Alternative Route Generation Process

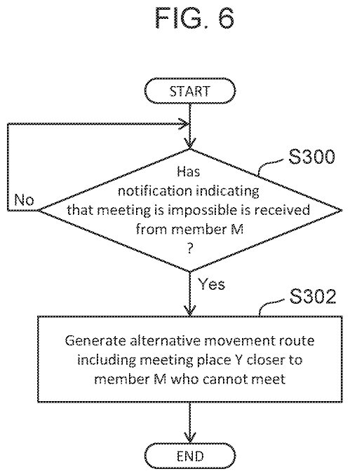

FIG. 6 is a flowchart showing a flow of the alternative route generation process according to the embodiment. The processing of this flowchart is executed during the execution of the movement using the assistance by the providing device 10. It should be noted that the alternative route generation process is included in the route generation process described above. Further, similarly to when the processing of step S212 shown in FIG. 3 is executed, the processor 14 executes the processing of steps S214 to S218, and steps S106 and S108 after generating an alternative movement route by the alternative route generation process.

In step S300, the processor 14 determines whether or not a notification (contact) indicating that it is impossible to meet at the meeting place Y already shared in the group G has been received from a member M (referred to as a “specific member” for convenience of description) who operates the communication terminal 20. The “meeting place Y already shared in the group G” referred to here includes one (referred to as a “specific meeting place” for convenience of description) of one or more meeting places Y set before the start of the movement using the assistance by the providing device 10, and a meeting place Y according to the additional request. Moreover, for example, the “notification” referred to here is voluntarily made to the providing device 10 by the member M (specific member) who has determined that the meeting is impossible. Furthermore, the response of disapproval by the member M (specific member) to the presentation of the “meeting place Y according to the additional request” from the providing device 10 corresponds to another example of the “notification”. It should be noted that the “specific member” may be one person or a plurality of persons.

When the processor 14 has received the notification (step S300; Yes), the processing proceeds to step S302. In step S302, the processor 14 generates an alternative movement route including a meeting place Y closer to a member M (specific member) who has performed the notification, than the meeting place (i.e., the specific meeting place or the meeting place Y according to the additional request) determined to be unable to meet by the member M. The processor 14 may receive at least one of a desired meeting place Yr and meeting time at which the members M can meet from a member M who has performed the notification, and may generate an alternative movement route based on at least one of the received meeting place Y and meeting time.

As described above, according to the alternative route generation process, it is possible to make it easy to meet with a member M that has become difficult to meet at the meeting place Y already shared in the group G, due to the situation on the day of the movement.

### 4-2. Notification Process

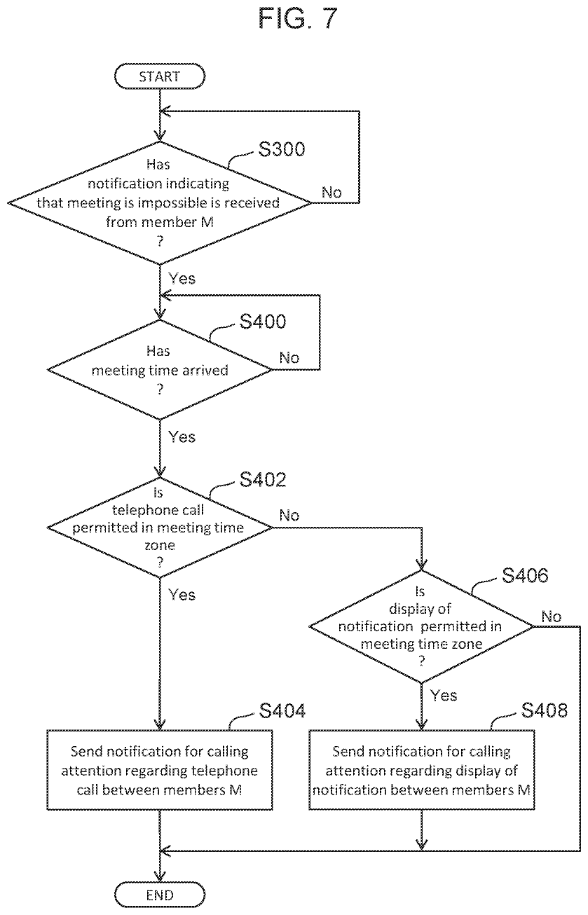

FIG. 7 is a flowchart showing a flow of the notification process according to the embodiment. The processing of this flowchart is repeatedly executed during the execution of the movement using the assistance by the providing device 10. More specifically, the processing of this flowchart is executed for each member M, targeting both a member M (specific member) who has performed the notification indicating that a meeting is impossible and one or more members M who are meeting at a meeting place (i.e., a specific meeting place, or a meeting place Y according to the additional request) determined to be unable to meet.

In FIG. 7, the processor 14 first executes the processing of step S300 similar to that of FIG. 6. As a result, when the processor 14 has received the above-described notification, that is, notification indicating that the meeting is impossible (step S300; Yes), the processing proceeds to step S400.

In step S400, the processor 14 determines whether or not the meeting time at the meeting place (i.e., the specific meeting place or the meeting place Y according to the additional request) determined, by the member M (the specific member) that has performed the notification, to be unable to meet has arrived. As a result, when the meeting time has arrived (step S400; Yes), the processing proceeds to step S402.

In step S402, the processor 14 determines whether or not the member M who is the target of the processing shown in FIG. 7 permits a telephone call between the members M in the meeting time zone of the meeting place. The information on permission/non-permission of the telephone call necessary for this determination is included in, for example, the member information MI input before the start of the movement using the assistance by the providing device 10.

When the determination result of step S402 is Yes (i.e., when the member M permits the telephone call in the meeting time zone), the processing proceeds to step S404. In step S404, the processor 14 sends a notification (for example, pop-up notification) for calling attention regarding the telephone call between the member M (specific member) who performed the notification and one or more members M who are meeting at the meeting place (i.e., the specific meeting place or the meeting place Y according to the additional request), to the member M who is the target of the processing shown in FIG. 7.

When, on the other hand, the determination result of step S402 is No (i.e., when the member M does not permit the telephone call in the meeting time zone), the processing proceeds to step S406.

In step S406, the processor 14 determines whether or not the member M who is the target of the processing shown in FIG. 7 permits display of a notification from another member M in the meeting time zone of the meeting place. Information on permission/non-permission of the display of the notification necessary for this determination is included in, for example, the member information MI input before the start of the movement using the assistance by the providing device 10. More specifically, the “display of notification” referred to here relates to a notification displayed on the screen of the communication terminal 20, and is for exchanging mutual information (for example, information such as a photograph regarding the meal content of the member M) between the members M who are at distant places. The notification is performed by using, for example, transmission of a chat or electronic mail, or mutual sharing of a data file such as a photograph.

When the determination result of step S406 is Yes (i.e., when the member M permits the display of the notification in the meeting time zone), the processing proceeds to step S408. In step S408, the processor 14 sends a notification (for example, pop-up notification) for calling attention regarding the display of notification between the member M (specific member) who has performed the notification and one or more members M who meet at the meeting place (i.e., the specific meeting place or the meeting place Y according to the additional request), to the member M which is the target of the processing shown in FIG. 7.

When, on the other hand, the determination result of step S406 is No (i.e., when the member M does not permit the display of the notification in the meeting time zone), the processing of the flowchart shown in FIG. 7 ends.

As described above, according to the notification process, it is possible to assist real-time information sharing by information exchange (telephone call or display of notification) in the meeting time zone between the members M who have difficulty in meeting due to the situation on the day of the movement.

What is claimed is:

1. A route information providing device for assisting movement of a group with a plurality of members, comprising:
a communication device configured to communicate with a communication terminal of each member of the group; and
a processor configured to execute:
a route generation process to generate a movement route of the each member including one or more meeting places where some or all members of the group meet, based on member information including a departure place, a departure time, one or more stop-off places, one or more desired meeting places, an arrival time at each of the one or more desired meeting places, and individual characteristics;
a time calculation process to calculate a meeting time of each of the one or more meeting places; and
a sharing process to share, in the group, a generated movement route of the each member and a calculated meeting time.

2. The route information providing device according to claim 1, wherein
in the sharing process, when an additional request from a member of the group to add a meeting place where some or all of the members of the group meet is received, the processor shares, in the group, the meeting place and a meeting time according to the additional request.

3. The route information providing device according to claim 1, wherein
the route generation process includes an alternative route generation process that, when a notification from a specific member of the group to indicate that the specific member cannot meet at a specific meeting place included in the one or more meeting places is received, generates an alternative movement route including a meeting place closer to the specific member than the specific meeting place.

4. The route information providing device according to claim 2, wherein
the route generation process includes an alternative route generation process that, when a notification from a specific member of the group to indicate that the specific member cannot meet at the meeting place according to the additional request is received, generates an alternative movement route including a meeting place closer to the specific member than the meeting place according to the additional request.

5. The route information providing device according to claim 1, wherein
when receiving a notification from a specific member of the group to indicate that the specific member cannot meet at a specific meeting place included in the one or more meeting places, the processor executes a notification process to send a notification for calling attention to an exchange of information between the specific member and one or more members meeting at the specific meeting place after the meeting time at the specific meeting place arrives.

6. The route information providing device according to claim 2, wherein
when receiving a notification from a specific member of the group to indicate that the specific member cannot meet at the meeting place according to the additional request, the processor executes a notification process to send a notification for calling attention to an exchange of information between the specific member and one or more members meeting at the meeting place according to the additional request after the meeting time at the meeting place according to the additional request arrives.

7. A route information providing method of assisting movement of a group with a plurality of members, comprising:
generating a movement route of the each member including one or more meeting places where some or all members of the group meet, based on member information including a departure place, a departure time, one or more stop-off places, one or more desired meeting places, an arrival time at each of the one or more desired meeting places, and individual characteristics;
calculating a meeting time of each of the one or more meeting places; and
sharing, in the group, a generated movement route of the each member and a calculated meeting time.
